(19) United States
(12) Patent Application Publication
(10) Pub. No.: US 2025/0230989 A1
(43) Pub. Date: Jul. 17, 2025

(54) HEAT PIPE INTEGRATED WITHIN A FASTENER

(71) Applicant: Balachandran Rajagopal, Bengaluru (IN)

(72) Inventor: Balachandran Rajagopal, Bengaluru (IN)

(21) Appl. No.: 18/412,634

(22) Filed: Jan. 15, 2024

(51) Int. Cl. F28D 15/04; F16B 33/00

(52) U.S. Cl. CPC F28D 15/04; F16B 33/00

(57) ABSTRACT

A fastener with a heat pipe integrated therein is disclosed. The fastener with the heat pipe integrated therein comprises a head portion, a body portion extending from the head portion, and a tip portion extending from the body portion. The heat pipe is integrated within the fastener and adapted to withdraw heat away from the body portion of the fastener. The heat pipe contains working fluid that absorbs heat from at least one of the tip portion and the body portion of the fastener. The heat pipe extends through a hole defined within the head portion and through the hole defined within the body portion of the fastener such that the working fluid that flows through the heat pipe towards the head portion of the fastener channels heat away from the body portion of the fastener and discharges heat to the head portion of the fastener is also disclosed.

### FIELD OF THE INVENTION

This invention relates generally to a heat pipe integrated within a fastener, and more particularly to the heat pipe for withdrawing heat away from at least one of a tip portion and a body portion of the fastener by means of working fluid that flows through the heat pipe.

### BACKGROUND OF THE INVENTION

In a current mechanical design of a fastener, ambient air is allowed to circulate around an outer surface of the fastener that is at high temperature to cool the fastener. A transfer of heat from the fastener at high temperature to air at low temperature cools the fastener to a low operating temperature that is within its acceptable operating design temperature limits. The air that circulates around the outer surface of the fastener is at high temperature when it emerges after cooling the fastener. This air at high temperature that emerges after cooling the fastener is absorbed by atmosphere.

However, as the air is allowed to circulate around the outer surface of the fastener, heat is dissipated by the fastener to surrounding air by natural convection, and heat transfer from the fastener to the surrounding air occurs slowly. Moreover, fastening surfaces of the fastener that are secured to their mating surfaces and that operate in high temperature working environments are not in contact with the ambient air. Therefore, heat is transferred from the fastening surfaces of the fastener that are secured to their mating surfaces all along a longitudinal length of the fastener and are subsequently dissipated to the atmosphere by natural convection. Therefore, an efficiency of cooling the high temperature fastener via this technique is low. A solution is hereby proposed in this manuscript to circulate a working fluid through a heat pipe that is integrated within the fastener to cool at least one of the tip portion and the body portion of the fastener by a required temperature differential in accordance with operating design temperature requirements of the fastener. Thereby, an overall increase in a cooling efficiency of the fastener may be achieved by cooling the fastener by means of the heat pipe that is integrated within the fastener. In addition, the fastener may be deployed in a cooling mode for cooling the fastener in accordance with the operating design temperature requirements of the fastener. Moreover, as the working fluid is in a gaseous state after absorbing heat from at least one of the tip portion and the body portion of the fastener and that operates in the high temperature environment, at least one of the tip portion and the body portion of the fastener at high temperature is cooled far more rapidly than by circulating ambient air around the outer surface of the fastener. In addition, the fastener with the heat pipe integrated therein may be deployed in a heating mode for heating the fastener by heating the head portion of the fastener via an external heat source. The heat from the head portion of the fastener is allowed to flow through the heat pipe that is integrated therein, and discharged all along a longitudinal length of the fastener. Thereby, portions along the longitudinal length of the fastener may be heated when it is required in cold temperature working environments.

A traditional fastener comprises a head portion, a shank portion that extends from the head portion, a fastening portion that extends from the shank portion, and a tip portion that extends from the fastening portion. The shank portion and the fastening portion together constitute a body portion of the fastener. In an exemplary embodiment, when the fastener is a screw, a bolt, a rivet, a nut, and a nail, the fastening portion that extends from the shank portion is a threaded portion that mates with a corresponding threaded portion of its mating component. The ambient air at low temperature that is circulated around the outer surface of the fastener flows around the outer surface of the fastener and withdraws heat away from the outer surface of the fastener by natural convection. After absorbing heat from the outer surface of the fastener while flowing around the outer surface of the fastener, air at high temperature is dissipated to the atmosphere. However, a mass flow rate of air that is required to be circulated around the outer surface of the fastener to achieve the required temperature reduction in the fastener is high due to air that is required to be circulated along an entire longitudinal length of the fastener to cool the fastener (i.e. from the head portion of the fastener to the tip portion of the fastener). Moreover, due to the high mass flow rate of air that is required to be circulated around the outer surface of the fastener and also because the air is in the gaseous state with no change in the state of the air, a quantity of heat absorbed by ambient air from the fastener/unit mass of ambient air that circulates around the outer surface of the fastener is low. Owing to the high mass flow rate of the ambient air that is in the constant gaseous state with no change in its state, a thermal efficiency of absorbing heat from the fastener by the ambient air is low. Consequently, there exists a need for an improved cooling system for the fastener that would enable working fluid to flow through the heat pipe that is integrated within the fastener to withdraw heat away from at least one of the tip portion and the body portion of the fastener efficiently. Due to the change in the state of the working fluid from the solid/liquid state to the gaseous state as working fluid flows through the heat pipe that is integrated within the fastener, an efficiency of heat absorption by the working fluid from the tip portion and the body portion of the fastener is high.

The need has existed for many years, yet there is no fully satisfactory system to meet the need. In accordance with a long-recognized need, there has been developed the heat pipe that when integrated within the fastener would enable working fluid to flow through the heat pipe, thereby cooling the fastener and more particularly the body portion of the fastener that is secured to its mating surface. The working fluid that is channeled through the heat pipe integrated within the fastener changes its state from the solid/liquid state to the gaseous state as working fluid flows through the heat pipe. The working fluid that is channeled through the heat pipe integrated within the fastener is designed to provide a high thermal efficiency of cooling as well as a high operating efficiency of the fastener over its lifetime. More specifically, as the working fluid flowing through the heat pipe comes in contact with at least one of the tip portion and the body portion of the fastener and that operates in the high temperature environment, heat is absorbed by the working fluid from at least one of the tip portion and the body portion of the fastener and vaporizes rapidly. The rapid vaporization of the working fluid flowing through the heat pipe rapidly cools at least one of the tip portion and the body portion of the fastener. In addition, the heat absorption rate of working fluid is much higher than the heat absorption rate of ambient air due to the capacity of working fluid to absorb more heat/unit mass of working fluid as working fluid changes its state to the gaseous state from one of its solid state and its liquid state as working fluid flows through the heat pipe. This change in the state of the working fluid as working fluid flows through the heat pipe allows more heat to be absorbed/unit mass of working fluid than that of ambient air that is required for cooling the fastener. Moreover, as the working fluid changes from the solid/liquid state to the gaseous state as working fluid flows through the heat pipe that is integrated within the fastener due to rapid absorption of heat from at least one of the tip portion and the body portion of the fastener that is at high temperature, the heat is absorbed from the tip portion, the body portion of the fastener, as well as other portions of the fastener by natural convection.

### BRIEF DESCRIPTION OF THE INVENTION

In one aspect of the invention, a fastener with a heat pipe positioned within the fastener is described. The fastener with the heat pipe positioned within the fastener comprises a head portion, a body portion extending from the head portion, and a tip portion extending from the body portion. The heat pipe is positioned within the fastener and adapted to withdraw heat away from the body portion of the fastener to cool the body portion of the fastener.

In another aspect of the invention, a method of assembling the heat pipe within the fastener is described. The method comprises drilling a hole through a head portion of the fastener and through a body portion of the fastener, wherein the body portion of the fastener extends from the head portion of the fastener. The method further comprises inserting the heat pipe through the hole drilled through the head portion of the fastener such that the heat pipe is positioned within the body portion of the fastener and within the head portion of the fastener. The heat pipe withdraws heat away from the body portion of the fastener and discharges heat to the head portion of the fastener to cool the body portion of the fastener.

### BRIEF DESCRIPTION OF THE DRAWINGS

FIG. 1 is a schematic representation of a fastener in one embodiment of the invention.

FIG. 2 is a schematic representation of a heat pipe that is integrated within the fastener in the embodiment of the invention that is depicted in FIG. 1.

### DETAILED DESCRIPTION OF THE INVENTION

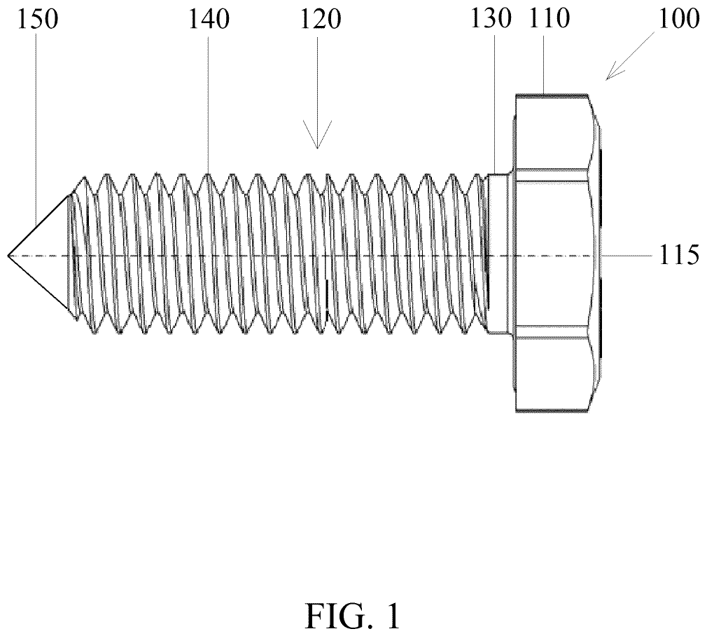

FIG. 1 is a schematic representation of a fastener 100 in one embodiment of the invention. The fastener 100 comprises a heat pipe (not shown) that is integrated within the fastener 100 and contains a working fluid therein. The working fluid that is contained within the heat pipe flows through the heat pipe for decreasing a temperature of the fastener 100. The working fluid that is contained within the heat pipe is circulated within the heat pipe to decrease the temperature of the fastener 100 that surrounds the heat pipe.

In an exemplary embodiment, the fastener 100 comprises a head portion 110. The head portion 110 of the fastener 100 comprises a drive 115 that is secured to a fastening tool, wherein the fastening tool tightens the fastener 100 against a mating surface of a mating component. The head portion 110 of the fastener 100 has an area of cross-section that is larger than an area of cross-section of a remaining portion of the fastener 100.

The fastener 100 comprises a body portion 120 that extends from the head portion 110 of the fastener 100. More specifically, the body portion 120 of the fastener 100 comprises a shank portion 130 that extends from the head portion 110 and a fastening portion 140 that extends from the shank portion 130. The fastening portion 140 of the fastener 100 is adapted to be fastened to the mating component (not shown) to secure the fastener 100 against the mating component. When the fastener 100 is a screw, a bolt, a rivet, a nut, and a nail, the fastening portion 140 of the fastener 100 is a threaded portion that is screwed onto screw threads that are defined on its mating component to facilitate securing the fastener 100 to its mating component. In an exemplary embodiment, the body portion 120 of the fastener 100 has an area of cross-section that is smaller than the area of cross-section of the head portion 110 of the fastener 100. In an alternate exemplary embodiment, the fastening portion 140 of the fastener 100 may be an unthreaded portion.

The fastener 100 comprises a tip portion 150 that extends from the body portion 120 of the fastener 100. More specifically, the tip portion 150 of the fastener 100 extends from the body portion 120. The tip portion 150 of the fastener 100 being pointed is adapted to guide the fastener 100 within a hole defined within its mating component (not shown) to secure the fastener 100 against its mating component. When the fastener 100 is the screw, the rivet, the nut, the nail, or the bolt, the tip portion 150 of the fastener 100 guides the body portion 120 within the hole that is defined in the mating component of the fastener 100. More specifically, the tip portion 150 of the fastener 100 guides the remaining portion of the fastener 100 within the hole that is defined in the mating component to secure the fastener 100 against its mating component. The tip portion 150 of the fastener 100 has an area of cross-section that is smaller than the area of cross-section of the body portion 120 of the fastener 100 and consequently smaller than the area of cross-section of the head portion 110 of the fastener 100.

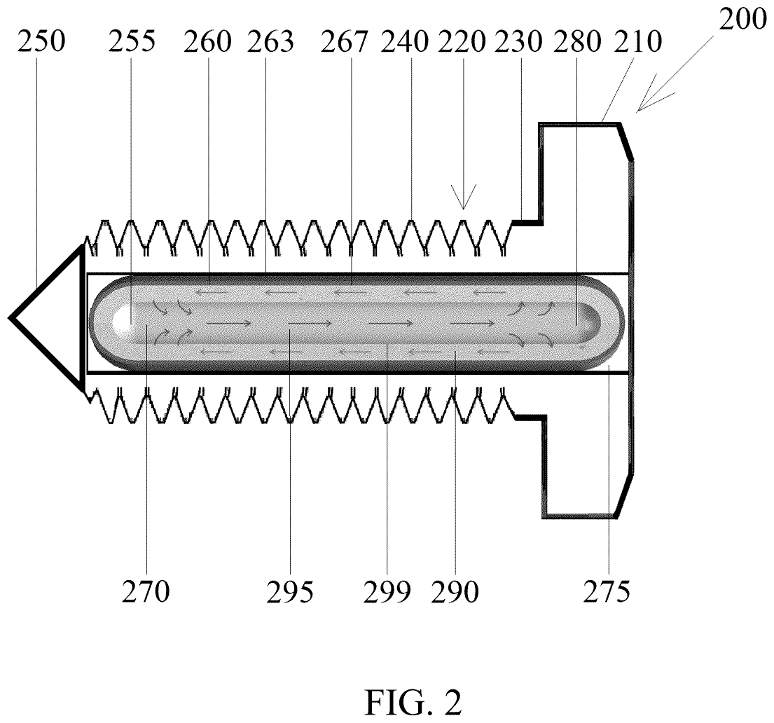

FIG. 2 is a schematic representation of the heat pipe 260 that is integrated within the fastener 200 in one embodiment of the invention. In an exemplary embodiment, the heat pipe 260 that is integrated within the fastener 200 is adapted to withdraw heat away from the body portion 220 of the fastener 200 to cool the body portion 220 of the fastener 200. In addition, the heat pipe 260 integrated within the fastener 200 is adapted to withdraw heat away from the tip portion 250 of the fastener 200 to cool the tip portion 250 of the fastener 200. When the fastener 200 is the screw, the bolt, the rivet, the nut, or the nail, the tip portion 250 of the fastener 200 is at high temperature during the fastening operation, and when exposed to a high temperature working environment. Therein, the heat pipe 260 that is integrated within the fastener 200 is adapted to withdraw heat away from at least one of the tip portion 250 and the body portion 220 of the fastener 200 in an efficient manner. Thereby, the tip portion 250 of the fastener 200 is cooled to a low temperature that is within its acceptable operating design temperature limits.

In an exemplary embodiment, the body portion 220 of the fastener 200 comprises the shank portion 230 and the fastening portion 240 extending from the shank portion 230 of the fastener 200. More specifically, the shank portion 230 of the fastener 200 extends from the head portion 210 of the fastener 200 and discharges heat to working fluid 255 that flows through the heat pipe 260. More specifically, the heat pipe 260 integrated within the fastener 200 contains working fluid 255 that absorbs heat from at least one of the body portion 220 and the tip portion 250 of the fastener 200. The working fluid 255 that absorbs heat from at least one of the body portion 220 and the tip portion 250 of the fastener 200 flows through the heat pipe 260 and discharges heat to the head portion 210 of the fastener 200.

In an exemplary embodiment, the heat pipe 260 integrated within the fastener 200 extends through a hole 275 defined within the head portion 210 of the fastener 200. The heat pipe 260 also extends through the hole 275 defined within the body portion 220 of the fastener 200, such that the working fluid 255 channels heat away from the body portion 220 of the fastener 200 and discharges heat to the head portion 210 of the fastener 200. More specifically, the working fluid 255 flowing through the heat pipe 260 absorbs heat from the body portion 220 of the fastener 200 and flows towards the head portion 210 of the fastener 200, thereby withdrawing heat and cooling the body portion 220 of the fastener 200. The hole 275 defined within the head portion 210 and within the body portion 220 is a single continuous hole that extends within the head portion 210 and within the body portion 220 of the fastener 200.

In an alternate exemplary embodiment, the heat pipe 260 integrated within the fastener 200 extends through the hole 275 defined within the head portion 210 of the fastener 200. In addition, the heat pipe 260 integrated within the fastener 200 that extends through the hole 275 defined within the head portion 210 of the fastener 200 further extends through the hole 275 defined within the body portion 220 of the fastener 200 to constitute a single continuous (unitary) heat pipe 260 that is in flow communication with the head portion 210 and with the body portion 220 of the fastener 200. Further, the heat pipe 260 integrated within the fastener 200 that extends through the hole 275 defined within the body portion 220 of the fastener 200 further extends through the hole 275 defined within the tip portion 250 of the fastener 200 to constitute a single continuous (unitary) heat pipe in flow communication with the head portion 210, the body portion 220, and the tip portion 250 of the fastener 200. The working fluid 255 channels heat away from the tip portion 250 and the body portion 220 of the fastener 200 to the head portion 210 of the fastener 200 as working fluid 255 flows through the heat pipe 260 towards the head portion 210 of the fastener 200, thereby cooling the body portion 220 and the tip portion 250 of the fastener 200 substantially. More specifically, the working fluid 255 absorbs heat from the body portion 220 and the tip portion 250 of the fastener 200 and flows through the heat pipe 260 towards the head portion 210 of the fastener 200, thereby withdrawing heat and cooling the body portion 220 and the tip portion 250 of the fastener 200. The working fluid 255 flowing through the heat pipe 260 discharges heat to the head portion 210 of the fastener 200. The hole 275 defined within the head portion 210, within the body portion 220, and within the tip portion 250 is a single continuous (unitary) hole 275 within which the heat pipe 260 is positioned.

The working fluid 255 that flows through the heat pipe 260 may be one of Ammonia, Hydrogen, Neon, Argon, Oxygen, Methane, Krypton, Ethane, Freon 22, Freon 21, Freon 11, Pentane, Freon 113, Acetone, Methanol, Ethanol, Water, Glycol, Helium, Nitrogen, Flutec PP2, Heptane, Toluene, Flutec PP9, Napthalene, Dowtherm, Thermex, Mercury, Sulphur, Caesium, Rubidium, Potassium, Sodium, Lithium, Calcium, Lead, Indium, and Silver. In an exemplary embodiment, the heat pipe 260 that is integrated within the fastener 200 comprises a hot end portion 270 that is located proximate to the tip portion 250 of the fastener 200 and a cold end portion 280 that is located proximate to the head portion 210 of the fastener 200. More specifically, the hot end portion 270 of the heat pipe 260 is located proximate to the tip portion 250 of the fastener 200 in the case where the heat pipe 260 extends through the body portion 220 of the heat pipe 260 until the end of the body portion 220 of the heat pipe 260. In addition, the hot end portion 270 of the heat pipe 260 may be located within the tip portion 250 of the fastener 200 in the case where the heat pipe 260 extends through the tip portion 250 of the heat pipe 260 and culminates anywhere within the tip portion 250 of the heat pipe 260. The heat absorbed from the body portion 220 of the fastener 200 by the working fluid 255 flows from the hot end portion 270 to the cold end portion 280 of the heat pipe 260 as working fluid 255 flows from the hot end portion 270 to the cold end portion 280 of the heat pipe 260 in the case where the heat pipe 260 is located proximate to the tip portion 250 of the fastener 200. Alternatively, the heat absorbed from the body portion 220 and the tip portion 250 of the fastener 200 by the working fluid 255 flows from the hot end portion 270 to the cold end portion 280 of the heat pipe 260 as working fluid 255 flows from the hot end portion 270 to the cold end portion 280 of the heat pipe 260 in the case where the heat pipe 260 extends within the body portion 220 and within the tip portion 250 of the fastener 200.

The fastener 200 further comprises a wick structure 290 that is positioned within the heat pipe 260 and against an inner wall 267 of the heat pipe 260. More specifically, the wick structure 290 that is positioned within the heat pipe 260 and against the inner wall 267 of the heat pipe 260 and extends from the hot end portion 270 of the heat pipe 260 to the cold end portion 280 of the heat pipe 260. More specifically, the wick structure 290 surrounds the inner wall 267 of the heat pipe 260 and extends from the hot end portion 270 of the heat pipe 260 to the cold end portion 280 of the heat pipe 260. The working fluid 255 flowing through the heat pipe 260 flows from the hot end portion 270 of the heat pipe 260 to the cold end portion 280 of the heat pipe 260 by flowing past wick structure 290. More specifically, the working fluid 255 flowing through the heat pipe 260 flows from the hot end portion 270 of the heat pipe 260 to the cold end portion 280 of the heat pipe 260 by flowing past an inner wall 299 of the wick structure 290 and through a cavity 295 that is defined within the heat pipe 260. Once the working fluid 255 from the hot end portion 270 of the heat pipe 260 flows through the cavity 295 that is defined within the heat pipe 260 and reaches the cold end portion 280 of the heat pipe 260, the working fluid 255 at the cold end portion 280 of the heat pipe 260 is absorbed by the wick structure 290. More specifically, the working fluid 255 is absorbed by the wick structure 290 that is in flow communication with the cold end portion 280 of the heat pipe 260 due to capillary force after heat is discharged by the working fluid 255 at the cold end portion 280 of the heat pipe 260. Once the cold working fluid 255 is absorbed by the wick structure 290 that is in flow communication with the cold end portion 280 of the heat pipe 260, the wick structure 290 channels cold working fluid 255 from the cold end portion 280 of the heat pipe 260 to the hot end portion 270 of the heat pipe 260 due to capillary action. Therefore, the temperature gradient between the hot end portion 270 of the heat pipe 260 and the cold end portion 280 of the heat pipe 260 causes working fluid 255 to flow from the hot end portion 270 to the cold end portion 280 of the heat pipe 260 by natural convection, thereby circulating the working fluid 255 from the hot end portion 270 to the cold end portion 280 of the heat pipe 260. Once the working fluid 255 is absorbed by the wick structure 290 at the cold end portion 280 of the heat pipe 290 after heat is discharged by the working fluid 255 at the cold end portion 280 of the heat pipe 260, capillary force causes the working fluid 255 to flow from the cold end portion 280 of the heat pipe 260 to the hot end portion 270 of the heat pipe 260, thereby circulating the working fluid 255 from the cold end portion 280 back to the hot end portion 270 of the heat pipe 260.

When the cold working fluid 255 is received at the hot end portion 270 of the heat pipe 260 from the wick structure 290, the working fluid 255 absorbs heat from at least one of the tip portion 250 and the body portion 220 of the fastener 220 that flows into the heat pipe 260. Due to heat that is received by the working fluid 255 from at least one of the tip portion 250 and the body portion 220 of the fastener 200, the temperature of the working fluid 255 is substantially increased from lower working temperature to higher working temperature. The working fluid 255 that flows through the cavity 295 defined within the heat pipe 260 to the cold end portion 280 of the heat pipe 260 discharges substantial amount of heat to the head portion 210 of the fastener 200 that is in thermal communication with the cold end portion 280 of the heat pipe 260. Due to discharge of heat from the working fluid 255 to the head portion 210 of the fastener 200, the temperature of the working fluid 255 is substantially decreased from higher working temperature to lower working temperature. This working fluid 255 at lower working temperature is absorbed by the wick structure 290 at the cold end portion 280 of the heat pipe 260 and subsequently circulated back to the hot end portion 270 of the heat pipe 260 via the wick structure 290 due to capillary action. Once the working fluid 255 is received at the hot end portion 270 of the heat pipe 260 via the wick structure 290, the working fluid 255 flows from the wick structure 290 into the cavity 295 defined within the heat pipe 260. Therein, the cycle is repeated with the absorption of heat by the working fluid 255 from at least one of the tip portion 250 and the body portion 220 of the fastener 200 and subsequently flows to the cold end portion 280 of the heat pipe 260 via the cavity 295.

In an exemplary embodiment, the wick structure 290 may be manufactured from a material such as but not limited to copper, aluminum, stainless steel, nickel, titanium, refrasil fiber, woven cloth, glass fiber, porous metal, and wire mesh. In an alternate exemplary embodiment, the wick structure 290 may be manufactured from any material that permits the wick structure 290 to function as described herein. When the working fluid 255 absorbs heat from at least one of the body portion 220 and the tip portion 250 of the fastener 200, the working fluid 255 changes its state from one of substantially solid state and substantially liquid state to substantially gaseous state. Once the working fluid 255 changes to the substantially gaseous state after absorbing heat from at least one of the tip portion 250 and the body portion 220 of the fastener 200, the working fluid 255 in the substantially gaseous state flows to the head portion 210 of the fastener 200 and discharges heat to the head portion 210 of the fastener 200. Therefore, the head portion 210 of the fastener 200 absorbs heat from the working fluid 255 at the cold end portion 280 of the heat pipe 260 and gets heated up to a high temperature.

In an exemplary embodiment, the head portion 210 of the fastener 200 has a larger area of cross-section than the body portion 220 of the fastener 200. Therefore, since the head portion 210 of the fastener 200 has a larger area of cross-section than the area of cross-section of the body portion 220 of the fastener 200, heat is discharged from the head portion 210 of the fastener 200 at a greater rate than at the body portion 220 of the fastener 200 to the atmosphere. In addition, since the head portion 210 of the fastener 200 has a larger area of cross-section than the tip portion 250 of the fastener 200, heat is discharged from the head portion 210 of the fastener 200 at the greater rate than at the tip portion 250 of the fastener 200. The heat pipe 260 that is integrated within the fastener 200 adjoins the inner wall of the fastener 200 and withdraws heat away from the body portion 220 of the fastener 200. In addition, the heat pipe 260 that is integrated within the fastener 200 adjoins the inner wall of the fastener 200 and withdraws heat away from the tip portion 250 of the fastener 200. In an exemplary embodiment, the fastener 200 may be one of a screw, a bolt, a rivet, a nut, and a nail.

In addition, a method of assembling the heat pipe 260 within the fastener 200 is described. The method comprises drilling the hole 275 through the head portion 210 of the fastener 200 and through the body portion 220 of the fastener 200. In an alternate exemplary embodiment, the method comprises drilling the hole 275 through the head portion 210 of the fastener 200, through the body portion 220 of the fastener 200, and through the tip portion 250 of the fastener 200. The body portion 220 of the fastener 200 extends from the head portion 210 of the fastener 200. In addition, the tip portion 250 of the fastener 200 extends from the body portion 220 of the fastener 200. In an exemplary embodiment, the heat pipe 260 is inserted through the hole 275 drilled through the head portion 210 of the fastener 200 such that the heat pipe 260 may be securely positioned within the body portion 220 of the fastener 200 and within the head portion 210 of the fastener 200. Therefore, the heat pipe 260 may be positioned within the head portion 210 of the fastener 200 and within the body portion 220 of the fastener 200 such that the heat pipe 260 withdraws heat away from the body portion 220 of the fastener 200 to the head portion 210 of the fastener 200 and discharges heat to the head portion 210 of the fastener 200 to cool the body portion 220 of the fastener 200. Consequently, the head portion 210 of the fastener 200 is heated due to the transfer of heat from the body portion 220 of the fastener 200 to the head portion 210 of the fastener 200. In an alternate exemplary embodiment, the heat pipe 260 is inserted through the hole 275 drilled through the head portion 210 of the fastener 200 such that the heat pipe 260 is securely positioned within the body portion 220, and within the tip portion 250 of the fastener 200, and within the head portion 210 of the fastener 200. The heat pipe 260 may be positioned with the hole 275 defined within the fastener 200 via a press fit arrangement. Therefore, the heat pipe 260 is positioned within the head portion 210 of the fastener 200, within the body portion 220 of the fastener 200, and within the tip portion 250 of the fastener 200 such that the heat pipe 260 withdraws heat away from the body portion 220 of the fastener 200 and away from the tip portion 250 of the fastener 200 towards the head portion 210 of the fastener 200 and discharges heat to the head portion 210 of the fastener 200 to cool the body portion 220 and the tip portion 250 of the fastener 200. Consequently, the head portion 210 of the fastener 200 is heated due to the transfer of heat from the body portion 220 of the fastener 200 and the tip portion 250 of the fastener 200 to the head portion 210 of the fastener 200. The body portion 220 of the fastener 200 comprises the fastening portion 240 and the shank portion 230 of the fastener 200 considered together.

Once the heat pipe 260 is inserted through the hole 275 drilled through the head portion 210 of the fastener 200 such that the heat pipe 260 is securely positioned within the body portion 220 of the fastener 200, the head portion 210 of the fastener 200 is sealed. Thereby, the heat pipe 260 is securely retained within the hole 275 drilled through the fastener 200 and is prevented from being withdrawn from the fastener 200. More specifically, once the heat pipe 260 is inserted through the hole 275 drilled through the head portion 210 of the fastener 200 such that the heat pipe 260 is securely positioned within the body portion 220 of the fastener 200, the head portion 210 of the fastener 200 is welded by means such as but not limited to spot welding. The welding of the head portion 210 of the fastener 200 after the heat pipe 260 is inserted through the head portion 210 of the fastener 200 ensures that the heat pipe 260 is retained within the hole 275 defined within the fastener 200 and is prevented from being withdrawn from the fastener 200. Alternatively, the heat pipe 260 may be sealed by adding filler material through the hole 275 defined within the head portion 210 of the fastener 200 after the heat pipe 260 is inserted through the hole 275 defined within the head portion 210 of the fastener 200 to seal the head portion 210 of the fastener 200.

The heat pipe 260 that is positioned within the hole 275 defined within the fastener 200 is partially filled with working fluid 255 that is in one of the substantially solid state and the substantially liquid state. When the working fluid 255 within the cavity 295 of the heat pipe 260 receives heat from at least one of the tip portion 250 of the fastener 200 and the body portion 220 of the fastener 200, the working fluid 255 changes from one of the substantially solid state and the substantially liquid state to the substantially gaseous state that flows through cavity 295 defined within the heat pipe 260 and decreases the temperature of at least one of the tip portion 250 of the fastener 200 and the body portion 220 of the fastener 200. More specifically, heat is absorbed by the working fluid 255 flowing through the cavity 295 defined within heat pipe 260 from at least one of the tip portion 250 of the fastener 200 and the body portion 220 of the fastener 200, thereby cooling at least one of the tip portion 250 and the body portion 220 of the fastener 200. The working fluid 255 flowing through the heat pipe 260 that is proximate to the tip portion 250 of the fastener 200 and the body portion 220 of the fastener 200 flows to the head portion 210 of the fastener 200 for discharging heat to the head portion 210 of the fastener 200. In an exemplary embodiment, the fastener 200 may be any kind of fastener 200 known in the art whose temperature is required to be decreased by the flow of working fluid 255 through the cavity 295 defined within the heat pipe 260 to the temperature that is within its acceptable operating design temperature limits. More specifically, the fastener 200 may be any fastener 200 known in the art that requires to be cooled from its higher operating temperature to its lower operating temperature as a consequence of heating up of the tip portion 250 of the fastener 200 as well as the body portion 220 of the fastener 200 that is secured against its mating surface and that absorbs heat from its mating surface of its mating component. More specifically, the mating surface against which the fastener 200 is secured is at a high working temperature as the mating surface of the mating component is in thermal communication with a high working temperature of its working environment. In an alternate exemplary embodiment, the fastener 200 and the mating surface against which the fastener 200 is secured are at high working temperatures as the fastener 200 and its mating surface are in thermal communication with the high working temperature of its working environment. In yet another alternate exemplary embodiment, the fastener 200 is at high working temperature as the fastener 200 is in thermal communication with the high working temperature of its working environment. In an exemplary embodiment, the fastener 200 may be any fastener 200 that is deployed in any high temperature working environment and that absorbs heat from the high temperature working environment in applications such as in heat furnaces, automobile engines, aircraft engines, spacecraft engines, high temperature machines, high temperature railway lines, and the like. In an exemplary embodiment, the acceptable operating design temperature range of the fastener 200 may be between 273 K to 3000 K depending on the application where the fastener 200 is to be deployed. In an exemplary embodiment, the fastener 200 may be manufactured from a material such as but not limited to Stainless Steel, Copper, Silica, Nickel, Titanium, Aluminum, Cold Rolled Steel, Iron, Nickel, Brass, Tungsten, Tantalum, Molybdenum, Niobium, Inconel, and Rhenium, and deployed in its high temperature working environment.

Once the working fluid 255 decreases the temperature of at least one of the body portion 220 and the tip portion 250 of the fastener 200, the working fluid 255 that flows from the hot end portion 270 of the heat pipe 260 flows past the inner wall 299 of the wick structure 290 to the cold end portion 280 of the heat pipe 260 via the cavity 295 that is defined within the heat pipe 260. The working fluid 255 on flowing to the cold end portion 280 of the heat pipe 260 discharges heat to the head portion 210 of the fastener 200 that is in thermal communication with the cold end portion 280 of the heat pipe 260. The heat that is discharged to the head portion 210 of the fastener 200 flows via conduction to its outer surface and is subsequently discharged to its working environment by natural convection. More specifically, as the area of cross-section of the head portion 210 of the fastener 200 is greater than its body portion 220, heat is discharged rapidly from the head portion 210 of the fastener 200 to the external environment that at its body portion 220. As the working fluid 255 at the cold end portion 280 of the heat pipe 200 discharges heat to the head portion 210 of the fastener 200 that is in thermal communication with the cold end portion 280 of the heat pipe 260 by natural convection, its temperature decreases to a temperature that is below its phase transition temperature. Therein, the working fluid 255 changes its state from the substantially gaseous state to one of the substantially solid state and the substantially liquid state. The working fluid 255 after discharging heat to the head portion 210 of the fastener 200 is subsequently absorbed by the wick structure 290 due to capillary force. Therein, the wick structure 290 channels the working fluid 255 from the cold end portion 280 of the heat pipe 260 to the hot end portion 270 of the heat pipe 260 due to capillary action and delivers the working fluid 255 to the hot end portion 270 of the heat pipe 260 that is at high temperature. The working fluid 255 that is delivered to the hot end portion 270 of the heat pipe 260 at low temperature flows into the cavity 295 of the heat pipe 260. The working fluid 255 subsequently absorbs heat from the hot end portion 270 of the heat pipe 260 that is in thermal communication with at least one of the body portion 220 and the tip portion 250 of the fastener 200, and the cycle is repeated with the flow of working fluid 255 to the cold end portion 280 of the heat pipe 260 due to the temperature gradient that exists between the hot end portion 270 and the cold end portion 280 of the heat pipe 260.

In an exemplary embodiment, the heat pipe 260 integrated within the fastener 200 contains the working fluid 255 that is partially filled within the heat pipe 260. In an exemplary embodiment, the working fluid 255 that is deployed within the heat pipe 260 for the fastener 200 may be any kind of working fluid 255 known in the art that cools at least one of the body portion 220 and the tip portion 250 of the fastener 200. More specifically, the heat pipe 260 positioned within the fastener 200 encompasses a maximum possible surface area of the fastener 200 to facilitate absorbing maximum amount of heat from at least one of the body portion 220 and the tip portion 250 of the fastener 200. Therefore, the heat pipe 260 covers the maximum possible surface area of the fastener 200 to facilitate absorbing the maximum amount of heat from at least one of the body portion 220 and the tip portion 250 of the fastener 200 by the working fluid 255, thereby cooling the entire surface area of the fastener 200 excluding its head portion 210 effectively. Alternatively, the heat pipe 260 may extend along the longitudinal axis of the fastener 200 and then extend within the head portion 210 of the fastener 200 that is orthogonal to the longitudinal axis of the fastener 200 to encompass the maximum possible surface area of the fastener 200. In yet another alternate exemplary embodiment, the heat pipe 260 covers only a user defined surface area of the fastener 200 to facilitate absorbing the maximum amount of heat from the user defined surface area of the fastener 200. In an exemplary embodiment, the heat pipe 260 extends along a longitudinal length of the fastener 200 so as to encompass the maximum possible surface area of the fastener 200. Therefore, the working fluid 255 absorbs the maximum amount of heat from the entire surface area of the fastener 200 excluding its head portion 210. In addition, the heat pipe 260 may be integrally secured within the fastener 200. More specifically, in the exemplary embodiment, the heat pipe 260 may be an independently manufactured heat pipe 260 that may be cooled externally to a low temperature by placing it in a cold temperature external environment. The heat pipe 260 that is cooled to the low temperature consequently decreases in its diameter due to contraction. The heat pipe 260 at decreased diameter is therein inserted within the hole 275 that extends from the head portion 210 of the fastener 200 to one of an end of the body portion 220 and through the tip portion 250 of the fastener 200. The fastener 200 is subsequently warmed up. The heat pipe 260 on receiving heat within its structure increases in its diameter to a greater diameter than its diameter at low temperature, and therefore forms a press fit with the inner surface of the fastener 200 at ambient temperature. The heat pipe 260 when assembled in this manner forms a tight press fit arrangement with the inner surface of the fastener 200 at ambient temperature and may not be withdrawn from within the fastener 200. The heat pipe 260 that extends within the fastener 200 and that surrounds at least one of the body portion 220 of the fastener 200 and the tip portion 250 of the fastener 200 by being located within the hole 275 defined within the fastener 220 cools at least one of the body portion 220 of the fastener 200 and the tip portion 250 of the fastener 200 substantially.

In the exemplary embodiment, the working fluid 255 that is received at the hot end portion 270 of the heat pipe 260 from the wick structure 290 located proximate to the hot end portion 270 of the heat pipe 260 is received in one of a substantially liquid state and a substantially solid state. Once the working fluid 255 is received within the heat pipe 260 in one of the substantially liquid state and the substantially solid state, the working fluid 260 is allowed to flow through the cavity 295 defined within the heat pipe 260 to facilitate cooling at least one of the body portion 220 and the tip portion 250 of the fastener 200. More specifically, the working fluid 255 is allowed to flow through the cavity 295 that is defined within the heat pipe 260 positioned within the fastener 200 to facilitate cooling at least one of the tip portion 250 and the body portion 220 of the fastener 200. Therefore, the working fluid 255 that flows through the heat pipe 260 absorbs heat from at least one of the body portion 220 and the tip portion 250 of the fastener 200. The absorption of heat by the working fluid 255 that flows through the cavity 295 defined within the heat pipe 260 from at least one of the body portion 220 and the tip portion 250 of the fastener 200 cools the fastener 200 and consequently at least one of the body portion 220 and the tip portion 250 of the fastener 200 from its higher operating temperature to its lower operating temperature that is within the acceptable operating design temperature limits of the fastener 200. The decrease in the temperature of the fastener 200 and consequently at least one of the body portion 220 of the fastener 200 and the tip portion 250 of the fastener 200 to the lower operating temperature that is within its acceptable operating design temperature limits increases an operating efficiency and useful life of the fastener 200 as the fastening surfaces of the fastener 200 against its mating surface do not melt or soften over its useful life.

In an exemplary embodiment, the fastener 200 may be for but is not limited to be deployed in high temperature working environments such as in furnaces, automobiles, aircrafts, spacecrafts, high temperature machines, internal combustion engines, prime movers, utensils, household appliances, industrial appliances, and the like. Therefore, once the working fluid 255 flows through the heat pipe 260 that is positioned within the fastener 200, the working fluid 255 cools at least one of the body portion 220 of the fastener 200 and the tip portion 250 of the fastener 200 from its high working temperature to its low working temperature that is within its acceptable operating design temperature limits. More specifically, as the substantially liquid working fluid or substantially solid working fluid that is at low temperature at the hot end portion 270 of the heat pipe 260 flows through the cavity 295 defined within the heat pipe 260, heat from the high temperature working environment or the high temperature mating surface of the fastening portion 240 of the fastener 200 is transferred to the substantially liquid working fluid or substantially solid working fluid. More specifically, at least one of the body portion 220 and the tip portion 250 of the fastener 200 at high temperature is in indirect contact with working fluid 255 flowing from the hot end portion 270 of the heat pipe 260 to the cold end portion 280 of the heat pipe 260 via the cavity 295 defined within the heat pipe 260. The working fluid 255 transfers the heat away from at least one of the body portion 220 of the fastener 200 and the tip portion 250 of the fastener 200 as working fluid 255 flows from the hot end portion 270 of the heat pipe 260 to the cold end portion 280 of the heat pipe 260. The transfer of heat from at least one of the body portion 220 of the fastener 200 and the tip portion 250 of the fastener 200 that is positioned against the heat pipe 260 to the working fluid 255 converts the working fluid 255 that is in one of the substantially liquid state and substantially solid state to the working fluid 255 that is in the substantially gaseous state. The working fluid 255 that is in the substantially gaseous state on absorbing heat flows to the cold end portion 280 of the heat pipe 260 via the cavity 295 and past the wick structure 290 that is positioned against the inner wall 267 of the heat pipe 260 due to the temperature gradient that exists between working fluid at the hot end portion 270 of the heat pipe 260 and working fluid at the cold end portion 280 of the heat pipe 260.

In an exemplary embodiment, the heat pipe 260 positioned within the hole 275 defined in the fastener 200 that contains the working fluid 255 therein has a diameter that may be in the range of 1 millimeter to 100 millimeters to channel the working fluid 255 through the heat pipe 260. Alternatively, the diameter of the heat pipe 260 that contains the working fluid 255 therein may be in the order of any diametrical range known in the art that allows the working fluid 255 to flow from the hot end portion 270 of the heat pipe 260 to the cold end portion 280 of the heat pipe 260.

In an exemplary embodiment, at least one of the tip portion 250 of the fastener 200 and the body portion 220 of the fastener 200 that is positioned against the heat pipe 260 positioned within the fastener 200 becomes hot due to heat that is received from at least one of the high temperature working environment and the high temperature mating surface of its mating component against which the fastening portion 240 of the fastener 200 is secured. The heat from at least one of the tip portion 250 of the fastener 200 and the body portion 220 of the fastener 200 is discharged to the working fluid 255 that is in indirect contact via an outer wall 263 of the heat pipe 260 by convection and consequently heats the working fluid 255 that flows through the cavity 295 defined within the heat pipe 260. In an exemplary embodiment, the working fluid 255 that flows through the cavity 295 defined within the heat pipe 260 and in indirect contact with at least one of the tip portion 250 of the fastener 200 and the body portion 220 of the fastener 200 is partially filled within the heat pipe 260. In an alternate exemplary embodiment, the working fluid 255 that flows through the heat pipe 260 and is in indirect contact with at least one of the tip portion 250 of the fastener 200 and the body portion 220 of the fastener 200 is completely filled within the heat pipe 260. Therefore, the working fluid 255 that flows through the cavity 295 defined within the heat pipe 260 positioned within the fastener 200 cools at least one of the tip portion 250 of the fastener 200 and the body portion 220 of the fastener 200 that is positioned against the outer wall 263 of the heat pipe 260. More specifically, as the working fluid 255 flows through the cavity 295 that is defined within the heat pipe 260, the heat that is discharged from at least one of the tip portion 250 of the fastener 200 and the body portion 220 of the fastener 200 that is positioned against the outer wall 263 of the heat pipe 260 is absorbed by the working fluid 255 through convection as working fluid 255 flows from hot end portion 250 of the heat pipe 260 to the cold end portion 280 of the heat pipe 260 via the cavity 295 defined within the heat pipe 260. The absorption of heat by the working fluid 255 from the fastener 200 cools at least one of the heated tip portion 250 of the fastener 200 and the heated body portion 220 of the fastener 200 substantially. Therefore, once the working fluid 255 flows through the heat pipe 260 that is integrated within the fastener 200, the working fluid 255 cools at least one of the tip portion 250 of the fastener 200 and the body portion 220 of the fastener 200 substantially. More specifically, as the substantially liquid or the substantially solid working fluid that is at low temperature is received at the hot end portion 270 of the heat pipe 260 that is positioned within the fastener 200, heat from at least one of the tip portion 250 of the fastener 200 and the body portion 220 of the fastener 200 is transferred to the substantially liquid working fluid or the substantially solid working fluid that is in indirect contact via the outer wall 263 of the heat pipe 260 and that is in contact with at least one of the tip portion 250 and the body portion 220 of the fastener 200. The transfer of heat from at least one of the tip portion 250 of the fastener 200 and the body portion 220 of the fastener 200 that is positioned against the outer wall 263 of the heat pipe 260 to the working fluid 255 converts the working fluid 255 that is in the substantially liquid state or the substantially solid state to the working fluid 255 that is in the substantially gaseous state at high temperature. The working fluid 255 that is in the substantially gaseous state flows from the hot end portion 270 of the heat pipe 260 to the cold end portion 280 of the heat pipe 260 past the inner wall 299 of the wick structure 290 at higher temperature than that of the substantially liquid working fluid or the substantially solid working fluid at lower temperature received at the hot end portion 270 of the heat pipe 260 from the wick structure 290.

More specifically, as the substantially liquid working fluid or the substantially solid working fluid at low temperature is received in the cavity 295 defined at the hot end portion 270 of the heat pipe 260 from the wick structure 290 and flows through the cavity 295 defined in the heat pipe 260, heat from at least one of the tip portion 250 of the fastener 200 and the body portion 220 of the fastener 200 that is positioned against the outer wall 263 of the heat pipe 260 and is in indirect contact with the working fluid 255 is transferred to the working fluid 255 by convection. The transfer of heat from at least one of the tip portion 250 of the fastener 200 and the body portion 220 of the fastener 200 that is positioned against the outer wall 263 of the heat pipe 260 to the working fluid 255 that is in indirect contact with at least one of the tip portion 250 and the body portion 220 of the fastener 200 converts the working fluid 255 that is at lower temperature to the working fluid that is at higher temperature. The working fluid 255 on absorbing heat from at least one of the tip portion 250 of the fastener 200 and the body portion 220 of the fastener 200 and increasing its temperature subsequently flows to the cold end portion 280 of the heat pipe 260. The heat that is absorbed by the working fluid 255 from at least one of the tip portion 250 of the fastener 200 and the body portion 220 of the fastener 200 is discharged at the cold end portion 280 of the heat pipe 260, thereby resulting in the substantial decrease in the temperature of the working fluid 255. The heat that is discharged at the cold end portion 280 of the heat pipe 260 is discharged rapidly to the head portion 210 of the fastener 200 by convection. The heat from the head portion 210 of the fastener 200 flows towards its tip portion by conduction, is subsequently discharged to the external environment that is in thermal communication with the head portion 210 of the fastener 200 and is at a lower temperature than the head portion 210 of the fastener 200 by natural convection.

In an exemplary embodiment, the inner wall 267 of the heat pipe 260 that is positioned within the fastener 200 and in mechanical surface contact with the wick structure 290 may be manufactured from a material that can withstand pressurized corrosive working fluid 255 at low temperature as well as at high temperature at different operating conditions of the heat pipe 260. In an exemplary embodiment, the inner wall 267 of the heat pipe 260 that is positioned within the fastener 200 may be manufactured from but is not limited to a mild steel material, an aluminum material, a pressure resistant glass material, a pressure resistant plastic material, a pressure resistant ceramic material, an acrylic material, PVC, PTFE, and a pressure resistant polymer material. In an alternate exemplary embodiment, the inner wall 267 of the heat pipe 260 positioned within the fastener 200 may be manufactured from a high thermal conductivity material that facilitates efficient heat transfer from at least one of the body portion 220 and the tip portion 250 of the fastener 200 to the working fluid 255 that flows through the cavity 295 defined within the heat pipe 260 and is in indirect contact with at least one of the body portion 220 and the tip portion 250 of the fastener 200. Moreover, the inner wall 267 of the heat pipe 260 may be coated with a leak resistant material to ensure containment of working fluid 255 within the heat pipe 260 that is positioned within the fastener 200 itself without being discharged to the hole 275 defined within the fastener 200.

In an exemplary embodiment, the working fluid 255 that flows through the cavity 295 defined within the heat pipe 260 that is positioned within the fastener 200 to cool at least one of the body portion 220 and the tip portion 250 of the fastener 200 is of a specific heat absorption capacity/unit mass of the working fluid that is low. Therefore, since the specific heat absorption capacity/unit mass of the working fluid 255 that flows through the heat pipe 260 that is positioned within the fastener 200 is low, a low quantity of working fluid 255 is required to be filled within the heat pipe 260 that is positioned within the fastener 200. More specifically, the low quantity of working fluid 255 is required to be channeled through the heat pipe 260 that is positioned within the fastener 200 to decrease the first temperature of the fastener 200 and consequently at least one of the tip portion 250 and the body portion 220 of the fastener 200 to the second temperature that is within its acceptable operating design temperature limits. In addition, due to the low specific heat absorption capacity of the working fluid 255, the heat absorption rate of the working fluid 255 is high. Therefore, in order to decrease the temperature of the fastener 200 and consequently at least one of the tip portion 250 and the body portion 220 of the fastener 200 from the first temperature to the second temperature, the low mass flow rate of working fluid 255 that is capable of absorbing heat at the high rate is required to be channeled through the cavity 295 defined within the heat pipe 260. The low specific heat absorption capacity/unit mass of the working fluid 255 implies that the working fluid 255 that is channeled through the cavity 295 defined within the heat pipe 260 absorbs heat from the fastener 200 at the high rate to decrease the first temperature of the fastener 200 and consequently at least one of the tip portion 250 and the body portion 220 of the fastener 200 to the second temperature that is within its acceptable operating design temperature limits far more rapidly than air that is allowed to flow past the outer surface of the tip portion 250, the body portion 220, and the head portion 210 of the fastener 200 to cool the fastener 200.

Moreover, the energy that is required for causing the working fluid 255 to flow through the cavity 295 defined within the heat pipe 260 that is positioned within the fastener 200 is low because a low viscosity and consequently low inertia gaseous working fluid 255 is channeled through the cavity 295 defined within the heat pipe 260 to decrease the first temperature of the fastener 200 and consequently at least one of the tip portion 250 and the body portion 220 of the fastener 200 to the second temperature. The low viscosity of the working fluid 255 channeled through the caviy 295 defined within the heat pipe 260 that is positioned within the fastener 200 to cool the fastener 200 and consequently at least one of the tip portion 250 and the body portion 220 of the fastener 200 from the first temperature to the second temperature requires a low amount of energy for the working fluid 255 to flow through the cavity 295 defined in the heat pipe 260. The low viscosity of the working fluid 255 implies that a low inertia and consequently a low amount of energy is required to cause the less viscous working fluid 255 to flow through the cavity 295 defined within the heat pipe 260 and that is integrated within the fastener 200. In an exemplary embodiment, the fastener 200 comprises at least one of the tip portion 250 and the body portion 220 of the fastener 200 that is secured against the outer wall 263 of the heat pipe 260 that is positioned within the fastener 200. At least one of the tip portion 250 and the body portion 220 of the fastener 200 comprises at least one high temperature tip portion 250 and the high temperature body portion 220 of the fastener 200 that is at a temperature that is beyond its acceptable operating design temperature limits and therefore required to be cooled by the working fluid 255 that flows through the cavity 295 defined within the wick structure 290 of the heat pipe 260.

In an exemplary embodiment, the fastener 200 comprises the head portion 210, the body portion 220 (shank portion 230 and fastening portion 240) that extends from the head portion 210, and the tip portion 250 that extends from the body portion 220 of the fastener 200. More specifically, at least one of the tip portion 250 and the body portion 220 of the fastener 200 is required to be cooled by means of the working fluid 255 that flows through the cavity 295 defined within the heat pipe 260 to ensure that the temperature of at least one of the tip portion 250 and the body portion 220 of the fastener 200 is maintained within its acceptable operating design temperature limits. In an exemplary embodiment, the outer wall 263 of the heat pipe 260 that is positioned within the fastener 200 is positioned against and in mechanical contact with the inner wall of at least one of the tip portion 250 and the body portion 220 of the fastener 200 and conducts heat away from at least one of the tip portion 250 and the body portion 220 of the fastener 200. Thereby, the outer wall 263 of the heat pipe 260 that is in thermal contact with the inner wall of at least one of the tip portion 250 and the body portion 220 of the fastener 200 transfers heat to the working fluid that flows through the cavity 295 defined within the heat pipe 260. The working fluid 255 that flows through the cavity 295 defined within the heat pipe 260 is in indirect contact with at least one of the tip portion 250 and the body portion 220 of the fastener 200 via the outer wall 263 of the heat pipe 260.

In an exemplary embodiment, the hot end portion 270 of the heat pipe 260 receives the working fluid 255 that is in the substantially liquid state or the substantially solid state via the wick structure 290. The working fluid 255 that is received in the substantially liquid state or substantially solid state via the wick structure 290 flows past at least one of the tip portion 250 and the body portion 220 of the fastener 200 that is positioned against the outer wall 263 of the heat pipe 260 and that requires to be cooled. On flowing past at least one of the inner wall of at least one of the tip portion 250 and the body portion 230 of the fastener 200 and cooling at least one of the tip portion 250 and the body portion 230 of the fastener 200, the working fluid 255 flows to the cold end portion 280 of the heat pipe 260 via the cavity 295 due to the temperature gradient that exists between the hot end portion 270 and the cold end portion 280 of the heat pipe 260. In the exemplary embodiment, heat is discharged from the working fluid 255 to the cold end portion 280 of the heat pipe 260 before the working fluid 255 changes its state from the gaseous state to one of the substantially solid state and the substantially liquid state. The working fluid 255 at low temperature at the cold end portion 280 of the heat pipe 260 is substantially absorbed by the wick structure 290 that channels the working fluid 255 back to the hot end portion 270 of the heat pipe 260 after heat is discharged by the working fluid 255 at the cold end portion 280 of the heat pipe 260. As the working fluid 255 flows from the hot end portion 270 of the heat pipe 260 to the cold end portion 280 of the heat pipe 260 via the cavity 295 that is defined within the heat pipe 260, the working fluid 255 changes its state to the substantially gaseous state as a consequence of absorbing heat from the inner wall of at least one of the tip portion 250 and the body portion 220 of the fastener 200 that is positioned against the outer wall 263 of the heat pipe 260. Thereafter, the working fluid 255 in the substantially gaseous state at the greater temperature than the working fluid 255 that is received at the hot end portion 270 of the heat pipe 260 is channeled to the cold end portion 280 of the heat pipe 260. During the process of flow of working fluid 255 from the hot end portion 270 to the cold end portion 280 of the heat pipe 260 via the cavity 295, at least one of the tip portion 250 and the body portion 220 of the fastener 200 that is positioned against the outer wall 263 of the heat pipe 260 is cooled to the temperature that is within its acceptable operating design temperature limits. Therefore, the flow of working fluid 255 from the hot end portion 270 of the heat pipe 260 to the cold end portion 280 of the heat pipe 260 via the cavity 295 that is defined within the heat pipe 260 decreases the temperature of at least one of the tip portion 250 and the body portion 220 of the fastener 200 to the temperature that is within its acceptable operating design temperature limits. At least one of the tip portion 250 and the body portion 220 of the fastener 200 that requires to be cooled may be but is not limited to the tip portion 250, the shank portion 230, and the fastening portion 240 of the fastener 200. In an alternate exemplary embodiment, at least one of the tip portion 250 and the body portion 220 of the fastener 200 that is positioned against the heat pipe 260 that is positioned within the fastener 200 may be any kind of fastener 200 that requires to be cooled from the higher temperature to the lower temperature by means of the working fluid 255 that is received at the hot end portion 270 of the heat pipe 260 and that flows to the cold end portion 280 of the heat pipe 260 via the cavity 295 that is defined within the heat pipe 260.

The working fluid 255 that flows past at least one of the tip portion 250 and the body portion 220 of the fastener 200 cools at least one of the tip portion 250 and the body portion 220 of the fastener 200 that is positioned against the outer wall 263 of the heat pipe 260. The cooling of at least one of the tip portion 250 and the body portion 220 of the fastener 200 that is positioned against the outer wall 263 of the heat pipe 260 decreases the temperature of at least one of the tip portion 250 and the body portion 220 of the fastener 200 from its higher temperature to its lower temperature respectively and attain a temperature that is within its acceptable operating design temperature limits. Thereby, a longevity of at least one of the tip portion 250 and the body portion 220 of the fastener 200 that is positioned against the outer wall 263 of the heat pipe 260 that is positioned within the fastener 200 may be substantially enhanced as they do not soften or melt over a period of time when exposed to its high working temperatures.

In an exemplary embodiment, at least one of the tip portion 250 and the body portion 220 of the fastener 200 is at high temperature. The heat from at least one of the high temperature tip portion 250 and the high temperature body portion 220 of the fastener 200 is discharged to the working fluid 255 that flows through the cavity 295 defined within the heat pipe 260 positioned within the fastener 200. Therefore, the working fluid 255 that flows through the cavity 295 defined within the heat pipe 260 that is positioned within the fastener 200 cools at least one of the tip portion 250 and the body portion 220 of the fastener 200 that is positioned against the outer wall 263 of the heat pipe 260. More specifically, as the working fluid 255 flows through the cavity 295 defined within the heat pipe 260 that is integrated within the fastener 200, heat that is discharged from the inner wall of at least one of the tip portion 250 and the body portion 220 of the fastener 200 that is positioned against the outer wall 263 of the heat pipe 260 is absorbed by the working fluid 255 by convection as working fluid 255 flows from the hot end portion 270 of the heat pipe 260 to the cold end portion 280 of the heat pipe 260 via the cavity 295. The absorption of heat by the working fluid 255 from the inner wall of at least one of the tip portion 250 and the body portion 220 of the fastener 200 that is positioned against the heat pipe 260 positioned within the fastener 200 cools at least one of the heated tip portion 250 and the heated body portion 220 of the fastener 200. Therefore, once the working fluid 255 flows through the cavity 295 defined within the heat pipe 260 that is positioned within the fastener 200, the working fluid 255 cools at least one of the tip portion 250 and the body portion 220 of the fastener 200 to the temperature that is within its acceptable operating design temperature limits. More specifically, as the substantially liquid working fluid or the substantially solid working fluid that is at low temperature is received at the hot end portion 270 of the heat pipe 260 by flowing from the wick structure 290 into the cavity 295, heat from at least one of the tip portion 250 and the body portion 220 of the fastener 200 that is in thermal communication with the working fluid 255 is transferred to the working fluid 255 via the outer wall 263 of the heat pipe 260. The transfer of heat from the inner wall of at least one of the tip portion 250 and the body portion 220 of the fastener 200 that is positioned against the outer wall 263 of the heat pipe 260 to the working fluid 255 that flows through the cavity 295 defined within the heat pipe 260 increases the temperature of the working fluid 255 from low temperature to high temperature. The working fluid 255 after absorbing heat flows to the cold end portion 280 of the heat pipe 260 at the higher temperature than that of the working fluid 255 at the lower temperature that is received at the hot end portion 270 of the heat pipe 260 from the wick structure 290 that is in flow communication with the cavity 295 defined within the heat pipe 260.

In an exemplary embodiment, at least one inner wall 267 of the heat pipe 260 that is positioned within the fastener 200 may be manufactured from a material that can withstand pressurized corrosive working fluid 255 at low temperature as well as at high temperature. More specifically, as the working fluid 255 flows along the at least one inner wall 267 of the heat pipe 260 that is positioned within the fastener 200, the at least one inner wall 267 of the heat pipe 260 is susceptible to contraction due to the pressurized working fluid 255 at low temperature, thereby causing deformations to occur on the at least one inner wall 267 of the heat pipe 260. Therefore, the at least one inner wall 267 of the heat pipe 260 positioned within the fastener 200 is required to be manufactured from the material that can withstand pressurized corrosive working fluid 255 at low temperature to ensure that the heat pipe 260 does not contract or expand and break down, thereby causing leakage of the pressurized working fluid 255 from the heat pipe 260 to the hole 275 defined within the fastener 200. In an exemplary embodiment, the inner wall 267 of the heat pipe 260 that is positioned within the fastener 200 may be manufactured from but is not limited to a steel material, an aluminum material, a pressure resistant thermally conductive glass material, a pressure resistant thermally conductive plastic material, a pressure resistant thermally conductive polymer material, a thermally conductive acrylic material, thermally conductive PVC, thermally conductive PTFE, and a pressure resistant thermally conductive ceramic material. In an alternate exemplary embodiment, the at least one inner wall 267 and at least one outer wall 263 of the heat pipe 260 that is positioned within the fastener 200 may be manufactured from a high thermal conductivity material that facilitates efficient heat transfer from at least one of the tip portion 250 and the body portion 220 of the fastener 200 to the working fluid 255 that flows through the cavity 295 defined within the heat pipe 260 that is positioned within the fastener 200. Moreover, the at least one inner wall 267 of the heat pipe 260 positioned within the fastener 200 may be coated with leak resistant material to ensure containment of liquid/gaseous working fluid 255 within the cavity 295 defined within the heat pipe 260 that is positioned within the fastener 200 itself without being discharged to the external environment. In an exemplary embodiment, the working fluid 255 at high temperature on absorbing heat from the hot end portion 270 of the heat pipe 260 flows to the cold end portion 280 of the heat pipe 260. The heat is discharged at the cold end portion 280 of the heat pipe 260, and subsequently the working fluid 255 is absorbed within the wick structure 290 of the heat pipe 260 due to the porous nature of the wick structure 290.

Therefore, in this embodiment of the invention, working fluid 255 in the substantially solid state or in the substantially liquid state at low temperature is channeled from the hot end portion 270 of the heat pipe 260 to the cold end portion 280 of the heat pipe 260 via the cavity 295 and absorbs heat from at least one of the tip portion 250 and the body portion 220 of the fastener 200 by natural convection, thereby cooling the fastener 200 substantially. At the cold end portion 280 of the heat pipe 260, working fluid 255 at high temperature after absorbing heat from at least one of the tip portion 250 and the body portion 220 of the fastener 200 discharges a substantial amount of heat at the cold end portion 280 of the heat pipe 260. Thereby, the working fluid 255 changes its state from the gaseous state to one of the substantially liquid state or the substantially solid state and is subsequently absorbed by the wick structure 290 and channeled back to the hot end portion 270 of the heat pipe 260 and discharged into the cavity 295 therein. Thereafter, the cycle is repeated. In an exemplary embodiment, at least one fin (not shown) may be secured to an outer surface of the fastener 200 at the head portion 210 and receives heat from the head portion 210 of the fastener 200 and discharges heat to the atmosphere. The heat that is received by the at least one fin from the head portion 210 of the fastener 200 decreases a temperature of the head portion 210 of the fastener 200, thereby enabling the head portion 210 of the fastener 200 to absorb a substantial amount of heat from the cold end portion 280 of the heat pipe 260 once more.

The working fluid 255 that flows through the cavity 295 defined within the heat pipe 260 of the fastener 200 to cool the fastener 200 is of a specific heat absorption capacity/unit mass of the working fluid that is low. In addition, due to the low specific heat absorption capacity/unit mass of the working fluid 255, the heat absorption rate/unit mass of the working fluid 255 is high. Therefore, since the specific heat absorption capacity/unit mass of the working fluid 255 that flows through the cavity 295 defined within the heat pipe 260 is low, and that the heat absorption rate/unit mass of the working fluid 255 is high, a low mass flow rate of working fluid 255 is required to be channeled through the cavity 295 defined within the heat pipe 260 positioned within the fastener 200 to cool the inner wall and consequently at least one of the tip portion 250 and the body portion 220 of the fastener 200.

More specifically, the low mass flow rate of working fluid 255 is required to flow through the cavity 295 defined within the heat pipe 260 that is positioned within the fastener 200 to decrease the first temperature of the fastener 200 and consequently at least one of the tip portion 250 and the body portion 220 of the fastener 200 to the second temperature. Therefore, in order to decrease the temperature of the fastener 200 that comprises in part at least one of the tip portion 250 and the body portion 220 of the fastener 200, and that is positioned against the heat pipe 260 from the first temperature to the second temperature, a low mass flow rate of working fluid 255 is required flow through the cavity 295 defined within the heat pipe 260 positioned within the fastener 200 to decrease the first temperature of the fastener 200 and consequently at least one of the tip portion 250 and the body portion 220 of the fastener 200 to the second temperature. The low specific heat absorption capacity/unit mass of the working fluid 255 and its high heat absorption rate implies that a low mass flow rate of working fluid 255 that flows through the cavity 295 defined within the heat pipe 260 is sufficient to absorb a substantially same amount of heat from the fastener 200 that comprises at least one of the tip portion 250 and the body portion 220 of the fastener 200 to decrease the first temperature of the fastener 200 and consequently at least one of the tip portion 250 and the body portion 220 of the fastener 200 to the second temperature. In addition, owing to the low specific heat absorption capacity/unit mass of the working fluid 255, the heat absorption rate/unit mass of the working fluid 255 is high. In addition, the change in the state of the working fluid 255 from the substantially liquid state or the substantially solid state to the substantially gaseous state enables the working fluid 255 to absorb a high amount of heat (latent heat) from the fastener 200/unit mass of the working fluid 255 due to the change in the state of the working fluid 255. More specifically, the working fluid 255 absorbs heat in the form of latent heat from the fastener 200 during its process of conversion from the substantially liquid state or the substantially solid state to the substantially gaseous state, thereby enabling the working fluid 255 to absorb a high amount of heat from the fastener 200/unit mass of working fluid 255. Therefore, indirect working fluid based cooling by means of the working fluid 255 flowing through the heat pipe 260 for cooling the fastener 200 and consequently at least one of the tip portion 250 and the body portion 220 of the fastener 200 is a much better alternative than the air cooled based cooling methodology that is currently being deployed for cooling the fastener 200.

The working fluid 255 that flows past at least one of the tip portion 250 and the body portion 220 of the fastener 200 the inner wall of which is positioned against the heat pipe 260 cools the fastener 200, and consequently at least one of the tip portion 250 and the body portion 220 of the fastener 200. The cooling of the fastener 200 decreases the temperature of the fastener 200 and consequently at least one of the tip portion 250 and the body portion 220 of the fastener 200, the inner wall of which is positioned against the outer wall 263 of the heat pipe 260. Therefore, the fastener 200 and consequently at least one of the tip portion 250 and the body portion 220 of the fastener 200, the inner wall of which is positioned against the outer wall 263 of the heat pipe 260 are maintained within their respective acceptable operating design temperature limits, thereby enhancing a longevity and useful life of the fastener 200.

After working fluid 255 is channeled through the cavity 295 defined within the heat pipe 260, at least one of the tip portion 250 and the body portion 220 of the fastener 200, the inner wall of which are positioned against the heat pipe 260 may be cooled to the temperature that is within the acceptable operating design temperature limits of at least one of the tip portion 250 and the body portion 220 of the fastener 200. In an exemplary embodiment, the inner wall of at least one of the tip portion 250 and the body portion 220 of the fastener 200 may be positioned in mechanical contact against the outer wall 263 of the heat pipe 260, in thermal communication with the outer wall 263 of the heat pipe 260, and discharges heat to the outer wall 263 of the heat pipe 260 by conduction. The heat from the outer wall 263 of the heat pipe 260 is discharged to the working fluid 255 flowing through the cavity 295 defined within heat pipe 260 via its inner wall 267 by convection to heat the working fluid 255.

A working of the heat pipe 260 integrated within the fastener 200 is described as an example. In an exemplary embodiment, the working fluid 255 in the substantially liquid state or in the substantially solid state at low temperature is received within the cavity 295 defined at the hot end portion 270 of the heat pipe 260 integrated within the fastener 200 from the wick structure 290 at low temperature to cool at least one of the tip portion 250 and the body portion 220 of the fastener 200. Once the working fluid 255 is received within the cavity 295 defined at the hot end portion 270 of the heat pipe 260, the working fluid 255 absorbs heat from at least one of the tip portion 250 and the body portion 220 of the fastener 200 and increases in its temperature. The working fluid 255 at the higher temperature changes its state to a substantially gaseous state that flows through the cavity 295 defined within the heat pipe 260 that is positioned within the fastener 200 to the cold end portion 280 of the fastener 200. The flow of working fluid 255 through the cavity 295 defined within the heat pipe 260 that is positioned within the fastener 200 cools at least one of the tip portion 250 and the body portion 220 of the fastener 200.

More specifically, as the working fluid 255 flows through the cavity 295 defined within the heat pipe 260 to the cold end portion 280 of the heat pipe 260, the working fluid 255 absorbs heat indirectly from the inner wall of at least one of the tip portion 250 and the body portion 220 of the fastener 200 that is positioned against the outer wall 263 of the heat pipe 260 and gets heated. More specifically, the working fluid 255 gets heated due to the transfer of heat from the inner wall of at least one of the tip portion 250 and the body portion 220 of the fastener 200 that is positioned against the outer wall 263 of the heat pipe 260 to the working fluid 255 flowing through the cavity 295 defined within the heat pipe 260 by convection. The rapid absorption of heat by the working fluid 255 from at least one of the tip portion 250 and the body portion 220 of the fastener 200 changes the state of the working fluid 255 from the substantially liquid state or substantially solid state to the substantially gaseous state as working fluid 255 flows through the cavity 295 defined within the heat pipe 260. Therefore, when the working fluid 255 enters the hot end portion 270 of the heat pipe 260 from the wick structure 290, the working fluid 255 is at low temperature. However, as the working fluid 255 changes its state to the substantially gaseous state during the process of heat absorption from at least one of the tip portion 250 and the body portion 220 of the fastener 200 that is positioned against the outer wall 263 of the heat pipe 260 as working fluid 255 flows through the cavity 295 defined within the heat pipe 260, the working fluid 255 that flows to the cold end portion 280 of the heat pipe 260 is at higher temperature than the working fluid 255 that is received at the hot end portion 270 of the heat pipe 260 from the wick structure 290.

As heat flows from at least one of the tip portion 250 and the body portion 220 of the fastener 200 that is positioned against the outer wall 263 of the heat pipe 260 to the working fluid 255 that flows through the cavity 295 defined within the heat pipe 260, at least one of the tip portion 250 and the body portion 220 of the fastener 200 is substantially cooled from its higher working temperature to its lower working temperature that is within its acceptable operating design temperature limits. The working fluid 255 subsequently flows to the cold end portion 280 of the heat pipe 260 adjoining the head portion 210 due to the temperature gradient between the hot end portion 270 and the cold end portion 280 of the heat pipe 260, and discharges heat at the cold end portion 280 of the fastener 200. The heat that is discharged at the cold end portion 280 of the fastener 200 is absorbed by the head portion 210 of the fastener 200 that subsequently discharges the absorbed heat to the atmosphere after flowing to its tip portion by conduction. Therein, the working fluid 255 changes its state from the substantially gaseous state to the substantially liquid state or the substantially solid state and is subsequently absorbed within the wick structure 290 at the cold end portion 280 of the heat pipe 260. The wick structure 290 channels the working fluid 255 back to the hot end portion 270 of the heat pipe 260 by capillary action and delivers the working fluid 255 at low temperature to the cavity 295 defined within the heat pipe 260 adjoining at least one of the tip portion 250 and the body portion 220 of the fastener 200. While it is recognized that the temperature of the tip portion 250 and the body portion 220 of the fastener 200 do not attain a constant uniform temperature in practice, they are considered to be at the constant uniform temperature in this manuscript for simplicity.

The advantages of the heat pipe 260 integrated within the fastener 200 is described below for the understanding of a reader. Since a low mass flow rate of working fluid 255 is required to be channeled through the cavity 295 defined within the heat pipe 260 that is positioned within the fastener 200 to decrease the temperature of at least one of the tip portion 250 and the body portion 220 of the fastener 200, the mass flow rate of working fluid 255 required to cool the fastener 200 is low. In addition, since the low viscosity working fluid 255 at a corresponding low inertia is required to be channeled through the cavity 295 defined within the heat pipe 260 that is positioned within the fastener 200 to cool the fastener 200 and consequently at least one of the tip portion 250 and the body portion 220 of the fastener 200, the case of flowability of the working fluid through the heat pipe 260 is high. Further, material cost savings associated with utilizing the working fluid 255 for cooling the fastener 200 and consequently at least one of the tip portion 250 and the body portion 220 of the fastener 200 that does not require to be replaced over an entire lifespan of the fastener 200 is high. In addition, a maintenance cost associated with maintaining the proposed heat pipe 260 integrated within the fastener 200 that utilizes working fluid 255 that requires no service and mechanical maintenance is nil. Furthermore, the fastener 200 that when deployed in a high temperature working environment and/or when secured to the mating surface at high temperature expands, the contact surface between the fastening portion 240 of the fastener 200 and the high temperature mating surface decreases. The decrease in the contact surface between the fastening portion 240 of the fastener 200 and its mating surface results in the fastening portion 240 of the fastener 200 to loosen from its mating surface over a period of time. Therefore, when the fastener 200 that contains the heat pipe 260 integrated within the fastener 200 heats up, the working fluid 255 flowing through the cavity 295 defined within the heat pipe 260 rapidly absorbs the heat from at least one of the tip portion 250 and the body portion 220 of the fastener 200. The rapid absorption of heat by the working fluid 255 flowing through the cavity 295 defined within the heat pipe 260 from the inner wall of at least one of the tip portion 250 and the body portion 220 of the fastener 200 prevents the fastener 200 from expanding and thereby maintain the same contact surface between the fastening portion 240 of the fastener 200 and its mating surface. The heat pipe 260 that is deployed within the fastener 200 facilitates maintaining the near original dimensions of the fastener 200 over a long period of time when deployed in the high temperature working environment, which enhances the longevity and useful life of the fastener 200 substantially. Moreover, as the heat is transferred from at least one of the tip portion 250 and the body portion 220 of the fastener 200 to the head portion 210 of the fastener 200, the tip portion 250 and the body portion 220 of the fastener 200 may be manufactured from a low cost material having a low melting point and mechanically fastened to the head portion 210 of the fastener 200 that may be manufactured from a high cost material having a high melting point. Thereby, the cost of manufacturing the fastener 200 may be substantially decreased due to the usage of the low-cost material.

Therefore, the overall benefits associated with deploying the proposed working fluid 255 that is to be circulated through the cavity 295 defined within the heat pipe 260 integrated within the fastener 200 to cool at least one of the tip portion 250 and the body portion 220 of the fastener 200 is much better that the fastener 200 that does not contain the heat pipe 260 and is deployed in the high temperature working environment and/or when secured to its high temperature mating surface. The heat pipe 260 that is positioned within the hole 275 defined within the fastener 200 extends around the entire surface area of the fastener 200, thereby enabling the most efficient absorption of heat by the working fluid 255 flowing through the cavity 295 defined within the heat pipe 260 from the entire surface area of the fastener 200 excluding its head portion 210 and that is in indirect contact with at least one of the tip portion 250 and the body portion 220 of the fastener 200. Therefore, the heat pipe 260 that is positioned within the hole 275 drilled through the fastener 200 facilitates absorbing maximum amount of heat from at least one of the tip portion 250 and the body portion 220 of the fastener 200. Thereby, the respective temperatures of the tip portion 250 and the body portion 220 of the fastener 200 are decreased to attain a temperature that is within its acceptable operating design temperature limits. In addition, the terms ‘integrated’, ‘positioned’ ‘secured’, and ‘inserted’ may be used interchangeably in this manuscript.

Exemplary embodiments of the heat pipe 260 integrated within the fastener 200 for decreasing the temperature of the fastener 200 are described above in detail. The systems are not limited to the specific embodiments described herein, but rather components of each sub-system may be utilized separately and independently from other components described herein.

While the invention has been described in terms of various specific embodiments, those skilled in the art will recognize that the invention can be practiced with modifications within the spirit and scope of the claims.

What is claimed is:

1. A fastener with a heat pipe positioned within said fastener, said fastener with said heat pipe positioned within said fastener comprising:
a head portion;
a body portion extending from said head portion; and
a tip portion extending from said body portion, and wherein said heat pipe is positioned within said fastener and adapted to withdraw heat away from said body portion of said fastener to cool said body portion of said fastener.

2. A fastener with a heat pipe positioned within said fastener in accordance with claim 1, wherein said body portion of said fastener comprises a shank portion and a fastening portion extending from said shank portion of said fastener, and wherein said heat pipe is adapted to transfer heat to said body portion of said fastener to heat said body portion of said fastener.

3. A fastener with a heat pipe positioned within said fastener in accordance with claim 1, wherein said heat pipe positioned within said fastener contains working fluid that absorbs heat from at least one of said tip portion and said body portion of said fastener, and wherein at least one of said tip portion and said body portion of said fastener is in thermal communication with a source of heat at high temperature.

4. A fastener with a heat pipe positioned within said fastener in accordance with claim 3, wherein said heat pipe extends through a hole defined within said head portion of said fastener and through the hole defined within said body portion of said fastener such that said working fluid that flows through said heat pipe towards said head portion of said fastener channels heat away from said body portion of said fastener and discharges heat to said head portion of said fastener, thereby cooling said body portion of said fastener.

5. A fastener with a heat pipe positioned within said fastener in accordance with claim 3, wherein said heat pipe extends through a hole defined within said head portion of said fastener, through the hole defined within said body portion of said fastener, and through the hole defined within said tip portion of said fastener such that said working fluid that flows through said heat pipe towards said head portion of said fastener channels heat away from said tip portion and said body portion of said fastener and discharges heat to said head portion of said fastener, thereby cooling said tip portion and said body portion of said fastener.

6. A fastener with a heat pipe positioned within said fastener in accordance with claim 3, wherein said working fluid comprises one of Ammonia, Hydrogen, Neon, Argon, Oxygen, Methane, Krypton, Ethane, Freon 22, Freon 21, Freon 11, Pentane, Freon 113, Acetone, Methanol, Ethanol, Water, Glycol, Helium, Nitrogen, Flutec PP2, Heptane, Toluene, Flutec PP9, Napthalene, Dowtherm, Thermex, Mercury, Sulphur, Caesium, Rubidium, Potassium, Sodium, Lithium, Calcium, Lead, Indium, and Silver.

7. A fastener with a heat pipe positioned within said fastener in accordance with claim 3, wherein said heat pipe positioned within said fastener comprises a hot end portion that is located proximate to said tip portion of said fastener and a cold end portion that is located within said head portion of said fastener.

8. A fastener with a heat pipe positioned within said fastener in accordance with claim 7, wherein heat absorbed by said working fluid from at least one of said tip portion and said body portion of said fastener flows from said hot end portion to said cold end portion of said heat pipe as working fluid flows from said hot end portion to said cold end portion of said heat pipe.

9. A fastener with a heat pipe positioned within said fastener in accordance with claim 7, wherein heat absorbed by said working fluid from at least one of said tip portion and said body portion of said fastener increases a temperature of said working fluid from low temperature to high temperature as working fluid flows from said hot end portion to said cold end portion of said heat pipe.

10. A fastener with a heat pipe positioned within said fastener in accordance with claim 7, wherein heat absorbed by said working fluid from at least one of said tip portion and said body portion of said fastener is substantially discharged at said cold end portion of said heat pipe.

11. A fastener with a heat pipe positioned within said fastener in accordance with claim 7, further comprising a wick structure positioned within said heat pipe and extends from said hot end portion to said cold end portion of said heat pipe, wherein working fluid flows from said hot end portion to said cold end portion of said heat pipe by flowing past said wick structure and is absorbed by said wick structure at said cold end portion of said heat pipe after discharging heat at said cold end portion of said heat pipe, and wherein said wick structure channels working fluid from said cold end portion of said heat pipe to said hot end portion of said heat pipe by capillary action, thereby causing circulation of working fluid through said heat pipe.

12. A fastener with a heat pipe positioned within said fastener in accordance with claim 11, wherein said wick structure is manufactured from a material such as but not limited to copper, aluminum, stainless steel, nickel, titanium, refrasil fiber, woven cloth, glass fiber, porous metal, and wire mesh.

13. A fastener with a heat pipe positioned within said fastener in accordance with claim 3, wherein said working fluid changes its state from one of a substantially solid state and a substantially liquid state to a substantially gaseous state on absorbing heat from at least one of said tip portion and said body portion of said fastener, and wherein working fluid in the substantially gaseous state is channeled towards said head portion of said fastener for discharging heat to said head portion of said fastener.

14. A fastener with a heat pipe positioned within said fastener in accordance with claim 1, wherein said head portion of said fastener has an area of cross-section that is larger than an area of cross-section of said body portion of said fastener, thereby allowing for discharge of heat from said head portion of said fastener at a greater rate than at said body portion of said fastener to its environment.

15. A fastener with a heat pipe positioned within said fastener in accordance with claim 1, wherein said heat pipe positioned within said fastener is in mechanical contact with an inner wall of said fastener and withdraws heat away from said body portion of said fastener via said inner wall of said fastener.

16. A fastener with a heat pipe positioned within said fastener in accordance with claim 1, wherein said fastener comprises one of a screw, a bolt, a rivet, a nut, and a nail.

17. A method of assembling a heat pipe within a fastener, said method comprising:
drilling a hole through a head portion of the fastener and through a body portion of the fastener, wherein the body portion of the fastener extends from the head portion of the fastener; and
inserting the heat pipe through the hole drilled through the head portion of the fastener such that the heat pipe is positioned within the body portion of the fastener and within the head portion of the fastener, and wherein the heat pipe withdraws heat away from the body portion of the fastener and discharges heat to the head portion of the fastener to cool the body portion of the fastener.

18. A method of assembling a heat pipe within a fastener in accordance with claim 17, further comprising:
drilling the hole through a tip portion of the fastener, wherein the tip portion of the fastener extends from the body portion of the fastener; and
inserting the heat pipe through the hole drilled through the head portion of the fastener such that the heat pipe is positioned within the tip portion of the fastener, within the body portion of the fastener, and within the head portion of the fastener, and wherein the heat pipe withdraws heat away from the tip portion of the fastener, away from the body portion of the fastener and discharges heat to the head portion of the fastener to cool the tip portion of the fastener and the body portion of the fastener.

19. A method of assembling a heat pipe within a fastener in accordance with claim 17, further comprising sealing the head portion of the fastener after inserting the heat pipe through the hole drilled through the head portion of the fastener to retain the heat pipe within the fastener.

20. A method of assembling a heat pipe within a fastener in accordance with claim 19, wherein sealing the head portion of the fastener comprises one of welding the head portion of the fastener and adding filler material to the head portion of the fastener to seal the head portion of the fastener after inserting the heat pipe through the hole drilled through the head portion of the fastener to retain the heat pipe within the fastener.
